(19) United States
(12) Patent Application Publication
(10) Pub. No.: US 2010/0103397 A1
(43) Pub. Date: Apr. 29, 2010

(54) EXPOSURE APPARATUS, EXPOSURE METHOD, AND METHOD OF MANUFACTURING DISPLAY PANEL SUBSTRATE

(75) Inventors: Ryouji Nemoto, Saitama (JP); Tomoaki Hayashi, Saitama (JP); Satoshi Uehara, Saitama (JP); Mitsuyoshi Koizumi, Saitama (JP)

Correspondence Address: J C PATENTS, 4 VENTURE, SUITE 250, IRVINE, CA, 92618, US

(73) Assignee: HITACHI HIGH-TECHNOLOGIES CORPORATION, TOKYO (JP)

(21) Appl. No.: 12/540,879

(22) Filed: Aug. 13, 2009

(30) Foreign Application Priority Data
Oct. 23, 2008 (JP) 2008-272934

(51) Int. Cl. G03B 27/54; G03B 27/32

(52) U.S. Cl. 355/70; 355/77

(57) ABSTRACT

A position of a chuck 10 is detected. The movements of the stages 5 and 7 are controlled according to a result of detecting the position of the chuck 10, so as to position the chuck 10. Further, a light receiving means 51 is disposed on the chuck 10 for receiving a light beam irradiated from a head 20a of a light beam irradiation device 20. The misalignment of the head 20a of the light beam irradiation device 20 is detected based on the received light beam. According to a result of detecting the misalignment, a coordinate of drawing data supplied to a DMD driving circuit 27 of each light beam irradiation device 20 is modified. Moreover, the drawing data with the modified coordinate is supplied to the DMD driving circuit 27 of each light beam irradiation device 20.

### CROSS-REFERENCE TO RELATED APPLICATION

This application claims the priority benefit of Japan application serial no. 2008-272934, filed on Oct. 23, 2008. The entirety of the above-mentioned patent application is hereby incorporated by reference herein and made a part of specification.

### BACKGROUND OF THE INVENTION

1. Field of the Invention

The present invention is related to an exposure apparatus, an exposure method, and a method of manufacturing a display panel substrate which adopts the foregoing exposure apparatus and method, wherein the exposure apparatus and the exposure method are used for emitting a light beam to irradiate a substrate coated with a photoresist, scanning the substrate with the light beam to draw a pattern on the substrate in the manufacturing process of the display panel substrates of liquid crystal display devices. In particular, the present invention is related to an exposure apparatus and an exposure method which involve a plurality of light beam irradiation devices for scanning a substrate by a plurality of light beams, and is related to a method of manufacturing a display panel substrate which adopts the exposure apparatus and the exposure method.

2. Description of Related Art

Thin film transistor (TFT) substrates, color filter substrates, plasma display panel substrates, or electroluminescence (EL) display panel substrates used as display panels of liquid crystal display devices are manufactured by performing photolithography technologies to form patterns on substrates with use of exposure apparatuses. The following methods have been used in conventional exposure apparatuses: a projection method in which a pattern of a photomask (mask) pattern is projected on a substrate by using lenses or mirrors, a proximity method in which extremely small gaps (proximity gaps) are disposed between the mask and the substrate, for transferring the pattern of the mask onto the substrate.

In recent years, a kind of exposure apparatus as described below has been developed. In the exposure apparatus, a substrate having a photoresist coated thereon is irradiated by a light beam and scanned by the light beam to draw patterns on the substrate. Since the substrate is scanned by the light beam, and patterns are directly drawn on the substrate, there is no requirement for expensive masks. In addition, drawing data and scanning programs can be varied for adaptation to various sorts of display panel substrates. This kind of exposure apparatuses are, for example, disclosed in Japanese Patent Publication Number 2003-332221, Japanese Patent Publication Number 2005-353927, and Japanese Patent Publication Number 2007-219011.

In the manufacturing process of display panel substrates of liquid crystal display devices, more time is required for scanning the entire substrate if only one light beam is used because the exposed area is considerably wide. Consequently, tact time is prolonged. In order to shorten the tact time, it is required to dispose more than one light beam irradiation devices and use more than one light beams for scanning the substrate in parallel.

The scanning of substrate by the light beams is performed by moving the substrate relative to the light beams. Generally, light beam irradiation devices which include precise optical systems are fixed in certain positions, and a stage is used to move a chuck supporting the substrate. The optical system of each light beam irradiation device includes a head for irradiating the substrate with the light beam. The head may sometimes be misaligned from its original position due to the thermal expansion of a supporting element of the head, for example. When only one light beam irradiation device is equipped, and only one light beam is used to scan the entire substrate, the misalignment of the head of the light beam irradiation device is not a serious problem because the patterns on the substrate are as a whole misaligned. On the contrary, when several light beam irradiation devices are equipped, and several light beams are used to scan the substrate, the misalignments of the heads of the light beam irradiation devices cause the patterns to shift differently, which results in poor pattern quality.

### SUMMARY OF THE INVENTION

The present invention is directed to preventing pattern quality deterioration caused by misalignment of heads of light beam irradiation devices when the light beam irradiation devices are used for scanning a substrate with a plurality of light beams.

The present invention is further directed to manufacturing a high quality display panel substrate in a short period of time.

A characteristic of the present invention is an exposure apparatus or an exposure method, wherein a chuck supports a substrate coated with a photoresist. The chuck is moved by using a stage. The substrate is scanned by light beams irradiated from a plurality of light beam irradiation devices to draw pattern on the substrate. Each of the light beam irradiation devices includes a spatial light modulator which modulates the light beam, a driving circuit which drives the spatial light modulator according to drawing data, and a head having an irradiation optical system to emit the light beam modulated by the spatial light modulator. A characteristic of the exposure apparatus or the exposure method is that a position of the chuck is detected, and the stage is moved to position the chuck according to a detecting result. A light receiving means is disposed on the chuck to receive the light beam irradiated from the head of each of the light beam irradiation devices, and the misalignment of the head of each light beam irradiation device is detected and examined based on the received light beam. Further, a detecting result of the misalignment is based on to modify the coordinate of the drawing data supplied to the driving circuit of each of the light beam irradiation devices, and the drawing data with the modified coordinate is supplied to the driving circuit of each of the light beam irradiation devices.

The spatial light modulator of each of the light beam irradiation devices is formed by arranging a plurality of light-reflecting micro mirrors along two directions, and angles of the mirrors are varied by the driving circuit according to the drawing data, so as to modulate the light beam irradiating the substrate. The light beam modulated by the spatial light modulator is irradiated from the head of each of the light beam irradiation devices, and the head has the irradiation optical system. The position of the chuck is detected, and the stage is moved based on the detecting result, so as to position the chuck. Further, the chuck has the light receiving means disposed thereon to receive the light beam irradiated from the head of each of the light beam irradiation devices. Then, the misalignment of the head of each light beam irradiation device is detected according to the received light beam. The detecting result of the misalignment is based on to modify the coordinate of the drawing data supplied to the driving circuit of each light beam irradiation device, and the drawing data with the modified coordinate is supplied to the driving circuit of each light beam irradiation device. Accordingly, even if misalignment occurs, the pattern can be precisely drawn. Therefore, when more than one light beam irradiation devices are used to scan the substrate with more than one light beams, pattern quality deterioration caused by misalignment of the heads of light beam irradiation devices can be prevented.

Another characteristic of the present invention is hat a laser measurement system is used to detect the position of the chuck. The laser measurement system includes a laser source generating laser, a reflecting means disposed on the chuck, and an interferometer measuring an interference of the laser from the laser source and the laser reflected by the reflecting means. The laser measurement system is used to accurately detect and examine the position of the chuck, so as to precisely position the chuck. Thus, the misalignment of the head of each light beam irradiation device can be accurately detected based on the light beam received by the light receiving means on the chuck. Based on the above, the coordinate of the drawing data can be accurately modified for improving the preciseness of patterning.

Another characteristic of the present invention is that a plurality of light receiving means are disposed on the chuck and spaced by an interval which spaces the heads of the light beam irradiation devices, so as to receive the light beams irradiated from the heads of the light beam irradiation devices. Through using the light receiving means which are disposed on the chuck and spaced by the same interval which separates the heads of the light beam irradiation devices to receive the light beams from the heads, the movement range of the stage required for detecting the misalignment of the heads of all the light beam irradiation devices can be reduced. Accordingly, the area along the direction perpendicular to the scanning direction of the substrate by light beams of exposure apparatus can be reduced.

The exposure apparatus or the exposure method of the present invention can be applied to exposure of the substrate. By using parallel light beams to scan the substrate, patterns can be drawn precisely, and the time for manufacturing high quality display panel substrates can be reduced.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an exposure apparatus according to an embodiment of the present invention.

FIG. 2 is a lateral view of an exposure apparatus according to an embodiment of the present invention.

FIG. 3 is a front view of an exposure apparatus according to an embodiment of the present invention.

FIG. 4 is a schematic view of a light beam irradiation device.

FIG. 5 illustrates an act of a laser measurement system.

FIG. 6 illustrates an act of detecting the misalignment of heads of light beam irradiation devices.

FIG. 7 is a top view of a chuck as shown in FIG. 6.

FIG. 8 is a front view of the chuck as shown in FIG. 6.

FIG. 9 is a schematic view of a drawing controlling part.

FIGS. 10˜13 illustrate scanning a substrate with light beams.

FIG. 14 is a flowchart showing an exemplary process of fabricating a TFT substrate of a liquid crystal display device.

FIG. 15 is a flowchart showing an exemplary process of fabricating a color filter substrate of a liquid crystal display device.

### DESCRIPTION OF EMBODIMENTS

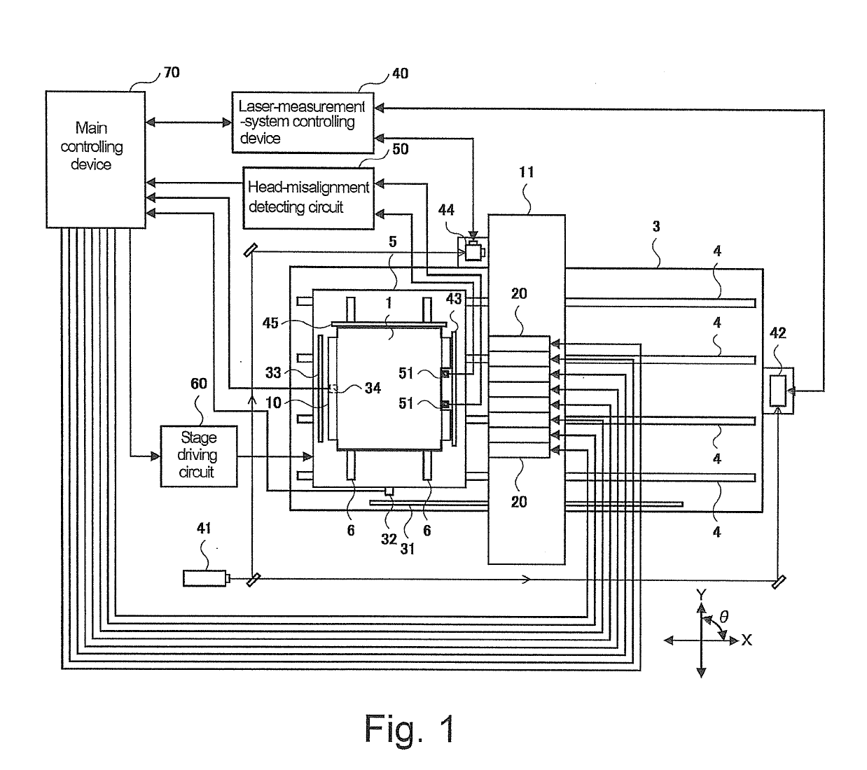

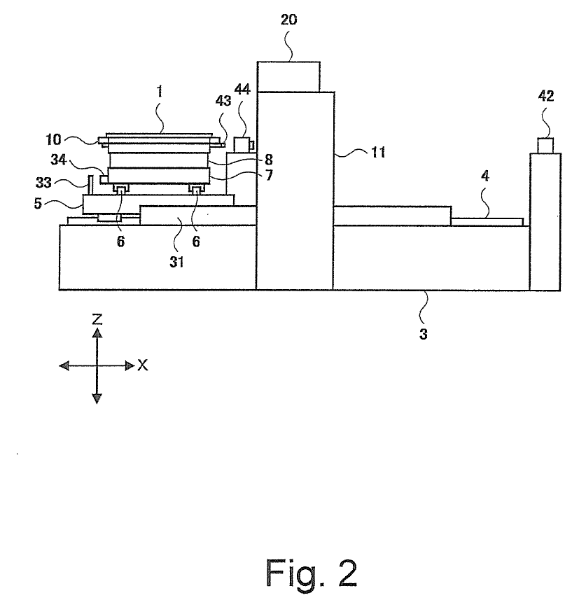

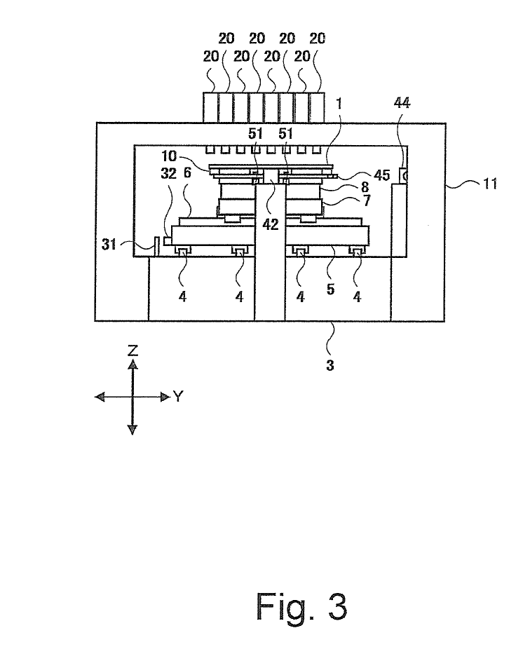

The following embodiments are described with reference to the examples shown in the enclosed figures. FIG. 1 is a schematic view of an exposure apparatus according to an embodiment of the present invention. In addition, FIG. 2 is a lateral view of the exposure apparatus according to an embodiment of the present invention, and FIG. 3 is a front view of the exposure apparatus according to an embodiment of the present invention. The exposure apparatus includes a base 3, an X-direction guide 4, an X-direction stage 5, a Y-direction guide 6, a Y-direction stage 7, a θ-direction stage 8, a chuck 10, a gate 11, light beam irradiation devices 20, linear scales 31 and 33, encoders 32 and 34, a laser measurement system, a laser-measurement-system controlling device 40, a head-misalignment detecting circuit 50, a charge-coupled device camera (CCD camera) 51, a stage driving circuit 60, and a main controlling device 70. It should be noted that a laser source 41 of the laser measurement system, the laser-measurement-system controlling device 40, the head-misalignment detecting circuit 50, the stage driving circuit 60, and the main controlling device 70 are omitted from FIG. 2 and FIG. 3. In addition to the above, the exposure apparatus further includes a supply unit for supplying a substrate 1 to the chuck 10, a retrieval unit for retrieving the substrate 1 from the chuck 10, and a temperature controlling unit for managing the temperature inside the apparatus.

The following embodiments are described with reference to the X and the Y directions, but it should be noted that the X direction and the Y direction can be varied.

As shown in FIG. 1 and FIG. 2, the chuck 10 is located in a supply-retrieval position for supplying and retrieving the substrate 1. In the aforesaid position, the substrate 1 is supplied to the chuck 10 by the supply unit (not shown) and retrieved from the chuck 10 by the retrieval unit (not shown). The chuck 10 supports a back side of the substrate 1 by vacuum suction. A surface of the substrate 1 is coated with a photoresist.

Above an exposure position where the substrate 1 is exposed, the gate 11 is disposed across the base 3. The gate 11 carries a plurality of light beam irradiation devices 20 thereon. It should be noted that, although the exposure apparatus described in the present embodiment has eight light beam irradiation devices 20, the present invention is not limited thereto. Within the spirit and scope of the present invention, the exposure apparatus can include two or more than two light beam irradiation devices.

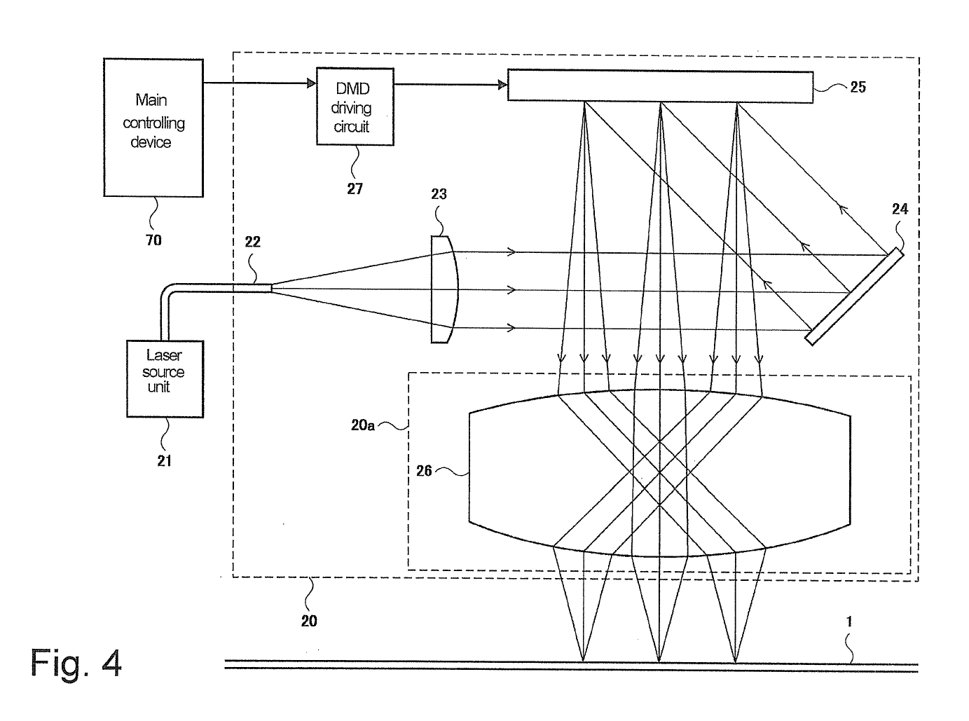

FIG. 4 is a schematic view of the light beam irradiation device. Each of the light beam irradiation devices 20 includes an optical fiber 22, a lens 23, a mirror 24, a digital micromirror device (DMD) 25, a projection lens 26, and a DMD driving circuit 27. The optical fiber 22 introduces an ultraviolet light beam which is generated by the laser source unit 21 into the light beam irradiation device 20. The light beam emitted from the optical fiber 22 irradiates the DMD 25 through the lens 23 and the mirror 24. The DMD 25 is a spatial light modulator formed by arranging a plurality of light-reflecting micro mirrors along two directions, and angles of the mirrors are varied so as to modulate the light beam. The light beam modulated by the DMD 25 is irradiated from a head 20a which contains the projection lens 26. The DMD driving circuit 27 varies the angle of each of the mirrors based on drawing data provided by the main controlling device 70.

Referring to FIG. 2 and FIG. 3, the chuck 10 is disposed on the θ-direction stage 8, and the Y-direction stage 7 and the X-direction stage 5 are disposed under the θ-direction stage 8. The X-direction stage 5 is disposed on the X-direction guide 4 which is disposed on the base 3, and the X-direction stage 5 moves towards the X direction along the X-direction guide 4. The Y-direction stage 7 is disposed on the Y-direction guide 6 which is disposed on the X-direction stage 5, and the Y-direction stage 7 moves towards the Y direction along the Y-direction guide 6. The θ-direction stage 8 is disposed on the Y-direction stage 7 and rotates towards a θ direction.

As the θ-direction stage 8 rotates towards the θ direction, the substrate 1 fixed onto the chuck 10 is rotated in a way that two perpendicular sides of the substrate 1 respectively face the X direction and the Y direction. As the X-direction stage 5 moves towards the X direction, the chuck 10 shifts between the supply-retrieval position and the exposure position. At the exposure position, the light beam irradiated from the head 20a of each of the light beam irradiation devices 20 scans the substrate 1 along the X direction as the X-direction stage 5 moves towards the X direction. Moreover, a region of the substrate 1, which is scanned by the light beam from the head 20a of each of the light beam irradiation devices 20, moves towards the Y direction as the Y-direction stage 7 moves towards the Y direction. Referring to FIG. 1, the stage driving circuit 60 is controlled by the main controlling device 70, so as to rotate the 0-direction stage 8 towards the θ direction, to move the X-direction stage 5 towards the X direction, and to move the Y-direction stage 7 towards the Y direction.

In FIG. 1 and FIG. 2, the linear scale 31 which extends towards the X direction is disposed on the base 3. The linear scale 31 has graduations thereon for measuring a movement of the X-direction stage 5 towards the X direction. Moreover, the linear scale 33 which extends towards the Y direction is disposed on the X-direction stage 5. The linear scale 33 also has graduations thereon for measuring a movement of the Y-direction stage 7 towards the Y direction.

Referring to FIG. 1 and FIG. 3, on one side of the X-direction stage 5, the encoder 32 is disposed opposite to the linear scale 31. The encoder 32 detects the graduations of the linear scale 31 and outputs pulse signals accordingly to the main controlling device 70. Further, referring to FIG. 1 and FIG. 2, on one side of the Y-direction stage 7, the encoder 34 is disposed opposite to the linear scale 33. The encoder 34 detects the graduations of the linear scale 33 and outputs pulse signals accordingly to the main controlling device 70. The main controlling device 70 counts the pulse signals from the encoder 32 to calculate the movement of the X-direction stage 5 towards the X direction and counts the pulse signals from the encoder 34 to calculate the movement of the Y-direction stage 7 towards the Y direction.

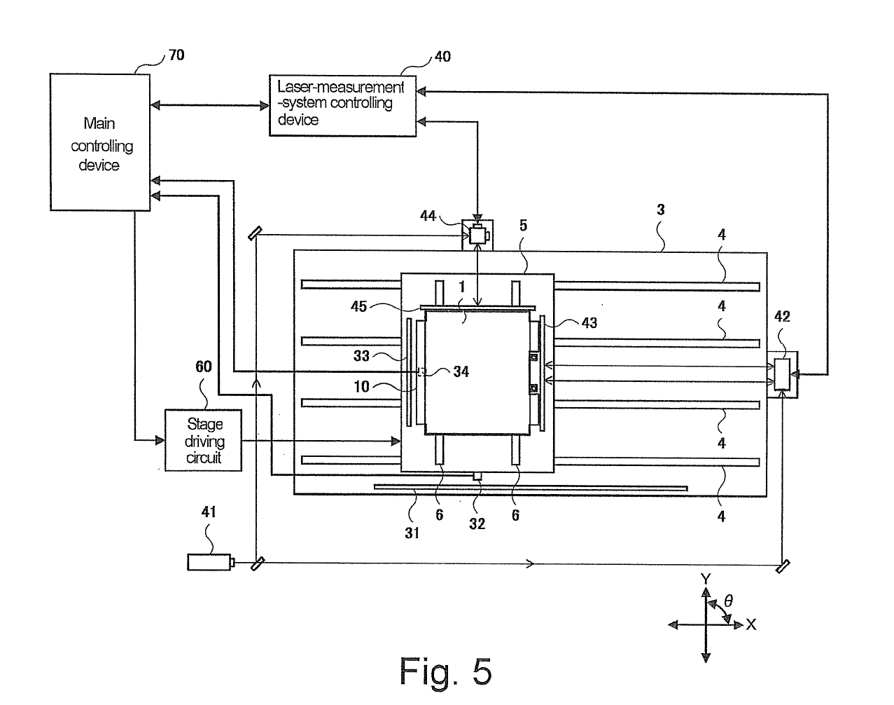

FIG. 5 illustrates an act of the laser measurement system. It should be noted that the gate 11 and the light beam irradiation devices 20 as shown in FIG. 1 are omitted from FIG. 5. The laser measurement system is a commonly-known laser interference measurement system and includes the laser source 41, laser interferometers 42 and 44, and bar mirrors 43 and 45. The bar mirror 43 is disposed on one side of the chuck 10 in the Y direction. In addition, the bar mirror 45 is disposed on another side of the chuck 10 in the X direction.

The laser interferometer 42 irradiates the bar mirror 43 with a laser from the laser source 41 and receives the laser reflected by the bar mirror 43, so as to measure an interference of the laser from the laser source 41 and the laser reflected by the bar mirror 43. The measurement is performed in two positions along the Y direction. The laser-measurement-system controlling device 40, under control of the main controlling device 70, detects the position and rotation of the chuck 10 in the X direction based on a detecting result generated by the laser interferometer 42.

Furthermore, the laser interferometer 44 irradiates the bar mirror 45 with the laser from the laser source 41 and receives the laser reflected by the bar mirror 45, so as to measure the interference of the laser from the laser source 41 and the laser reflected by the bar mirror 45. The laser-measurement-system controlling device 40, under control of the main controlling device 70, detects the position of the chuck 10 in the Y direction based on a detecting result generated by the laser interferometer 44.

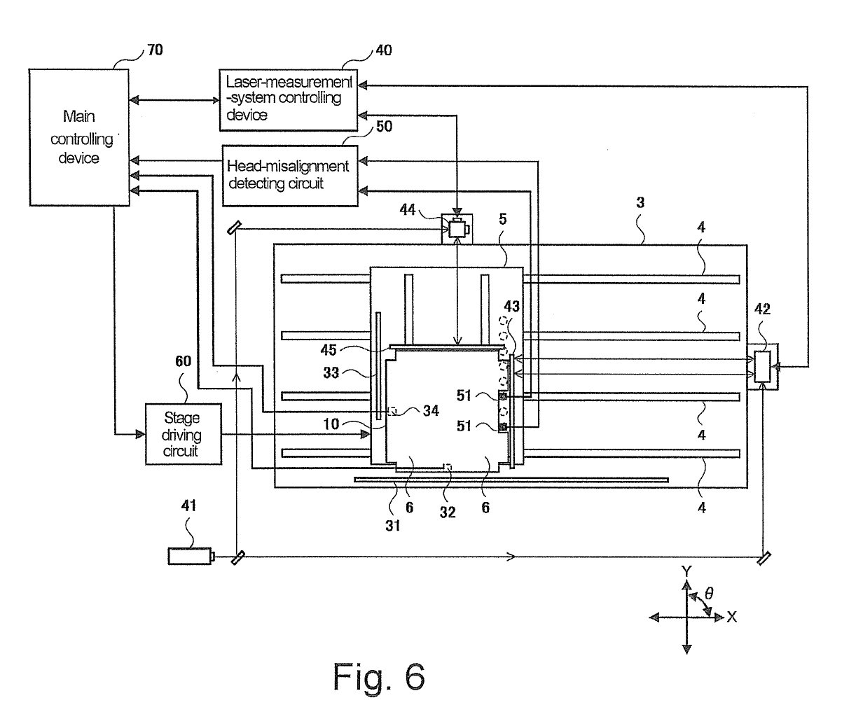

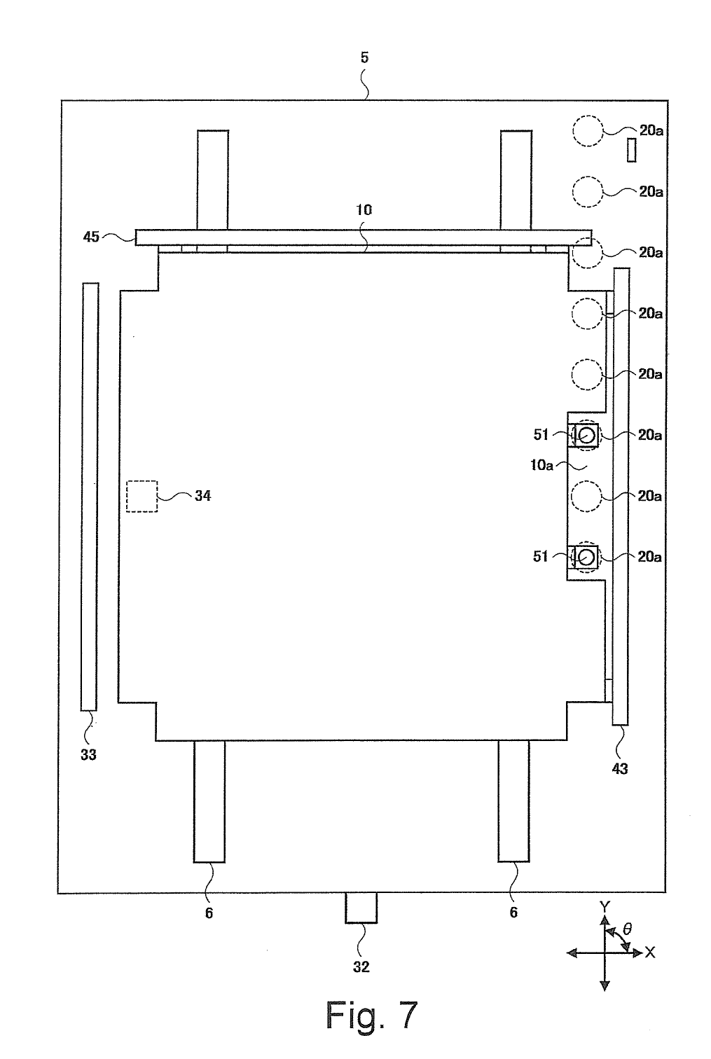

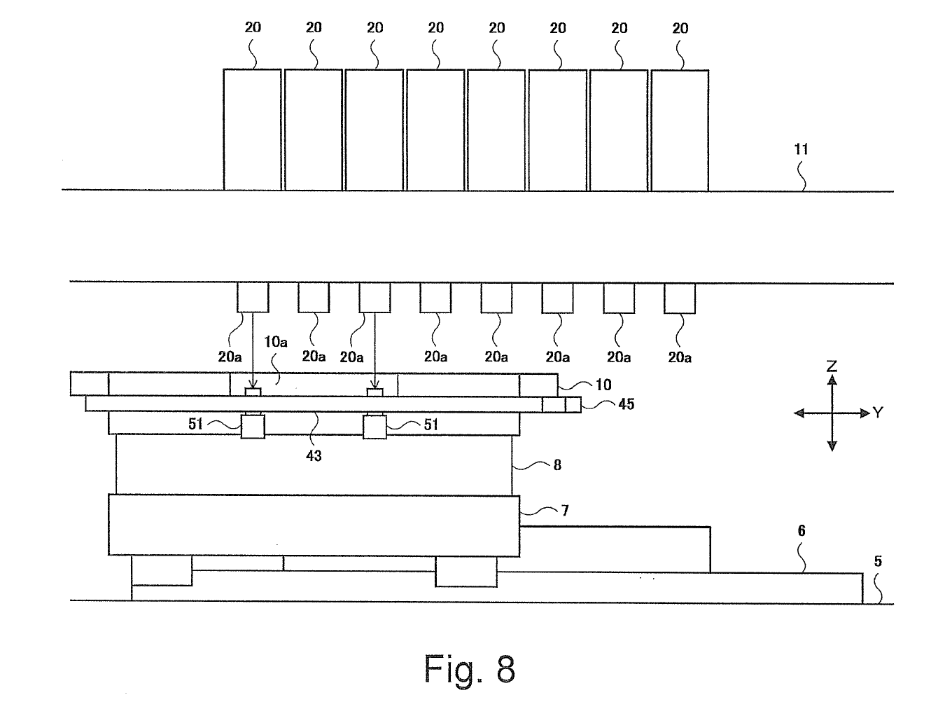

In this embodiment, the misalignment of the head 20a of each light beam irradiation device 20 is periodically detected before the substrate 1 is exposed. FIG. 6 illustrates an act of detecting the misalignment of the heads of the light beam irradiation devices 20. FIG. 7 is a top view of the chuck in FIG. 6, and FIG. 8 is a front view of the chuck in FIG. 6. Moreover, it should be noted that the gate 11 and the light beam irradiation devices 20 as shown in FIG. 1 are omitted from FIG. 6 and FIG. 7, and the heads 20a of the light beam irradiation devices 20 are represented by dotted lines.

With reference to FIG. 7 and FIG. 8, a notch part 10a is located on the chuck 10, and two CCD cameras 51 are disposed on the notch part 10a. The heads 20a of the light beam irradiation devices 20 are spaced by an interval along the Y direction. The two CCD cameras 51 are located on the chuck 10 and spaced by the same interval. A focus of each CCD camera 51 is equal to a surface height of the substrate 1 on the chuck 10. It should be noted that, although this embodiment discloses that two CCD cameras 51 are disposed on the chuck 10, in other embodiments the chuck 10 can also have three or more than three CCD cameras 51 thereon.

Referring to FIG. 6, when the chuck 10 carries no substrate thereon, the main controlling device 70 controls the stage driving circuit 60 to move the X-direction stage 5 towards the X direction according to the detecting result generated by the laser-measurement-system controlling device 40, so as to position the chuck 10 along the X direction in a way that the positions of the two CCD cameras 51 disposed on the chuck 10 correspond to the fixed positions of the heads 20a of the light beam irradiation devices 20 in the X direction. In the meantime, the laser measurement system is used to accurately detect the position of the chuck 10 in the X direction. Thus, the chuck 10 can be positioned precisely along the X direction.

Thereafter, the main controlling device 70 controls the stage driving circuit 60 to move the Y-direction stage 7 towards the Y direction according to the detecting result generated by the laser-measurement-system controlling device 40, so as to position the chuck 10 along the Y direction in a way that the positions of the two CCD cameras 51 disposed on the chuck 10 correspond to the fixed positions of the heads 20a of the light beam irradiation devices 20 in the Y direction. Meanwhile, the laser measurement system is used to accurately detect the position of the chuck 10 in the Y direction.

Thus, the chuck 10 can be positioned precisely along the Y direction. FIGS. 6˜8 show that the positions of the two CCD cameras 51 are corresponding to the fixed positions of the heads 20a of two light beam irradiation devices 20 in both the X direction and the Y direction.

Next, the main controlling device 70 supplies drawing data from the drawing controlling part to the DMD driving circuit 27 of the light beam irradiation devices 20 for detecting the misalignment of the heads 20a. Referring to FIG. 8, a light beam for detecting misalignment is irradiated from the head 20a of the light beam irradiation device 20 which has the drawing data. The light beam for detecting misalignment is made cross-like or comb-like, for example, which is suitable for image signal processing. Each of the CCD cameras 51 receives the light beam of detecting misalignment that is irradiated from the head 20a.

Referring to FIG. 6, each of the CCD cameras 51 outputs the image signal of the received light beam to the head-misalignment detecting circuit 50. The head-misalignment detecting circuit 50 processes the image signal from each CCD camera 51 and detects whether the heads 20a are misaligned from original positions in the X direction and the Y direction. At the same time, since the chuck 10 is precisely positioned in the X and the Y directions, the misalignment of the heads 20a of the light beam irradiation devices 20 in the X and the Y directions can be accurately detected and examined.

After detecting the misalignment of the heads 20a of two light beam irradiation devices 20, the main controlling device 70 controls the stage driving circuit 60 to move the Y-direction stage 7 towards the Y direction according to the detecting result generated by the laser-measurement-system controlling device 40, so as to position the chuck 10 along the Y direction in a way that the positions of the CCD cameras 51 disposed on the chuck 10 correspond to the original positions of the heads 20a of another two light beam irradiation devices 20 in the Y direction. Then, the positions of the heads 20a of another two light beam irradiation devices 20 in the X and the Y directions are detected and examined in the same way. The foregoing steps are repeated to detect and examine the misalignment of the heads 20a of all the light beam irradiation devices 20 in the X and the Y directions.

Because the CCD cameras 51 on the chuck 10 are spaced by the same interval which separates the heads 20a of the light beam irradiation devices 20 for receiving the light beams from the heads 20a, the movement range of the Y-direction stage 7 that is required for detecting the misalignment of the heads 20a can be reduced.

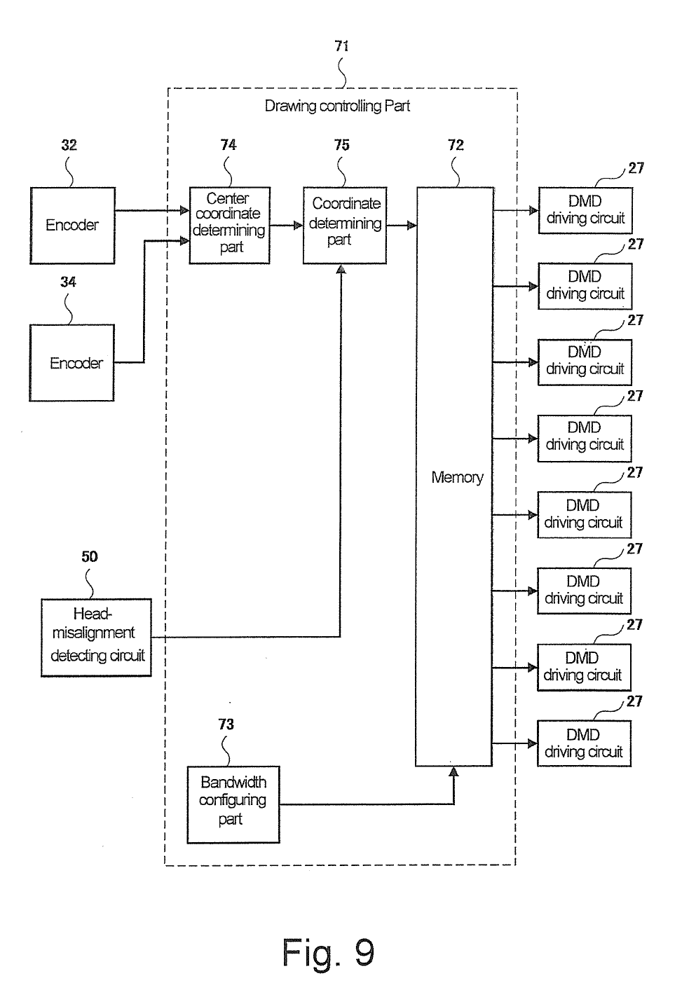

With reference to FIG. 1, the main controlling device 70 includes a drawing controlling part for supplying drawing data to the DMD driving circuit 27 of the light beam irradiation device 20. FIG. 9 is a schematic view of the drawing controlling part. The drawing controlling part 71 includes a memory 72, a bandwidth configuring part 73, a center coordinate determining part 74, and a coordinate determining part 75. The memory 72 records the XY coordinate of the drawing data as an address. Here, the drawing data is supplied to the DMD driving circuit 27 of each light beam irradiation device 20.

The bandwidth configuring part 73 determines a range of the Y coordinate of the drawing data read from the memory 72 and thereby configures a bandwidth of the light beam irradiated from the head 20a of the light beam irradiation device 20 in the Y direction.

The center coordinate determining part 74 counts the pulse signals outputted from the encoders 32 and 34, so as to detect and measure the movement of the X-direction stage 5 towards the X direction and the movement of the Y-direction stage 7 towards the Y direction, and thereby the XY coordinate of the center of the chuck 10 is determined. The coordinate determining part 75 determines the XY coordinate of the drawing data that is supplied to the DMD driving circuit 27 of each light beam irradiation device 20 according to the XY coordinate of the center of the chuck 10 that is determined by the center coordinate determining part 74. Thereafter, the coordinate determining part 75 modifies the determined XY coordinate according to the detecting result generated by the head-misalignment detecting circuit 50. The memory 72 inputs the XY coordinate modified by the coordinate determining part 75 as an address and outputs the drawing data recorded in the address of the inputted XY coordinate to the DMD driving circuit 27 of each light beam irradiation device 20.

The misalignment of the head 20a of each light beam irradiation device 20 is detected, and the detecting result is based on to modify the coordinate of the drawing data supplied to the DMD driving circuit 27 of each light beam irradiation device 20. Moreover, the drawing data with the modified coordinate is provided to the DMD driving circuit 27 of each light beam irradiation device 20. Accordingly, even if misalignment occurs, the pattern can be precisely drawn.

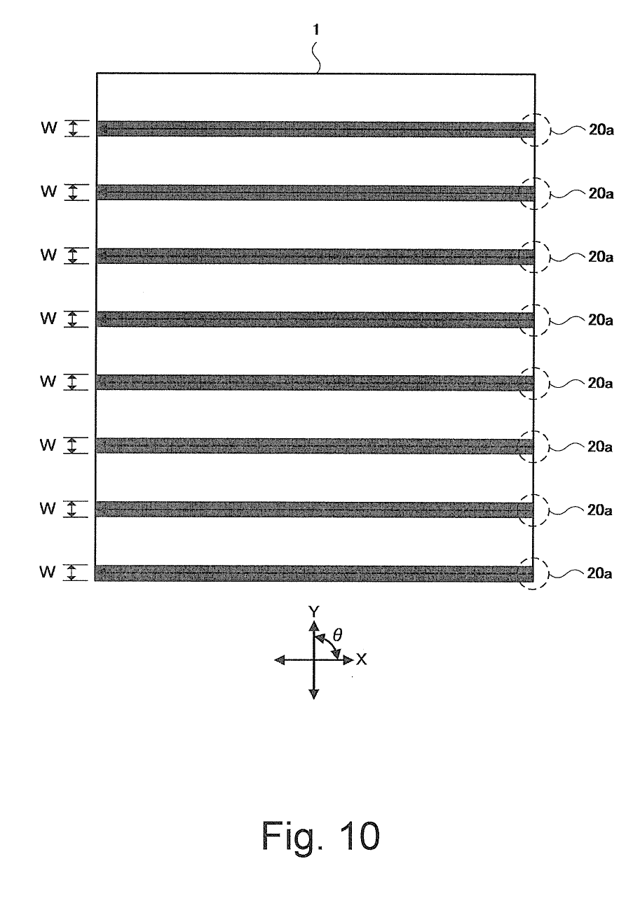

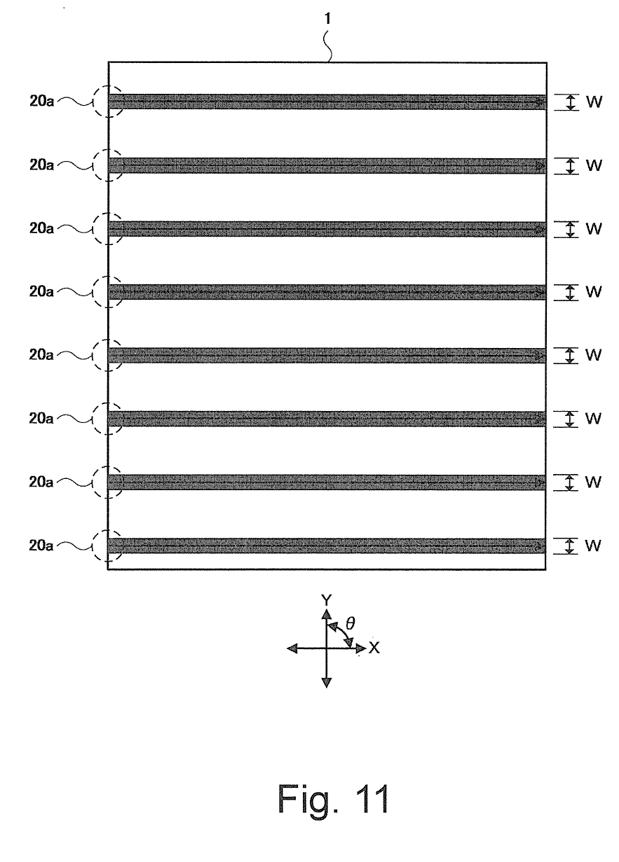

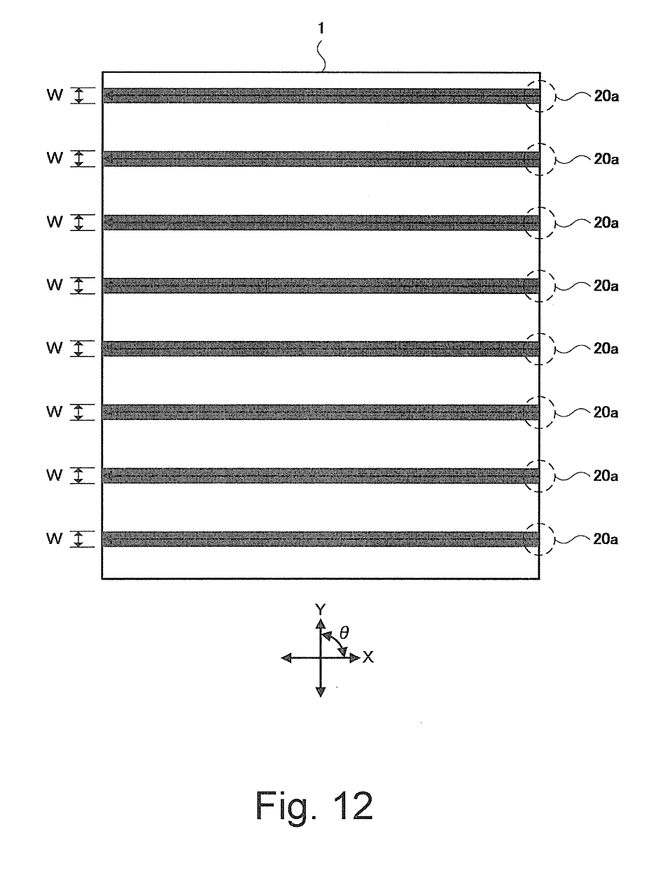

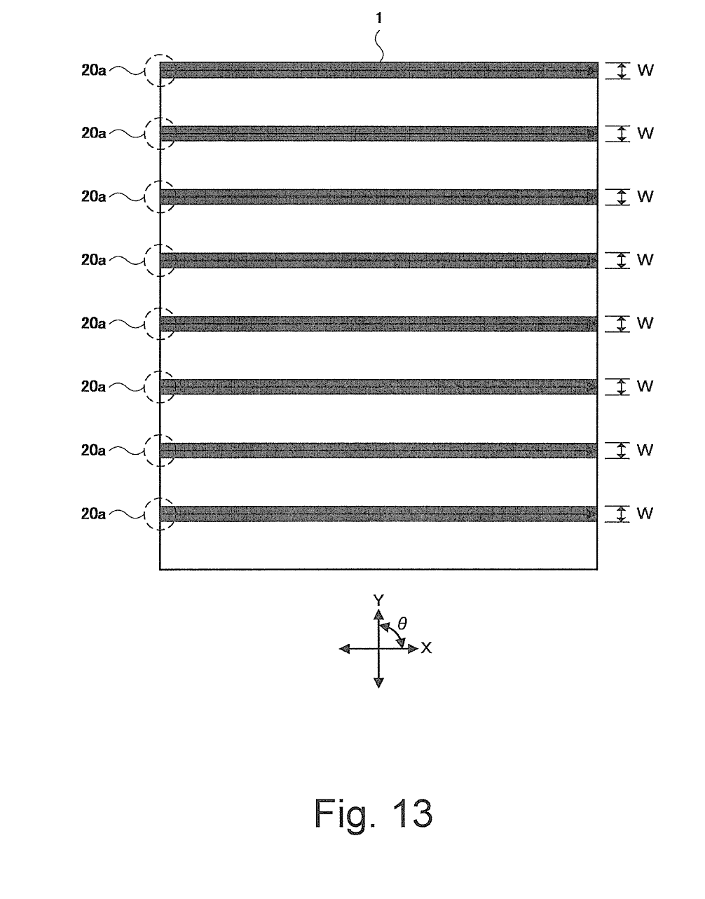

FIGS. 10˜13 illustrate scanning a substrate with light beams. FIGS. 10˜13 show that eight light beams irradiated from eight light beam irradiation devices 20 are used to scan the substrate 1 four times in the X direction, so as to scan the entire substrate 1. In FIGS. 10˜13, the head 20a of each light beam irradiation device 20 is represented by dotted lines. The light beam irradiated from the head 20a of each light beam irradiation device 20 has a bandwidth W in the Y direction, and the light beam scans the substrate 1 along a direction indicated by the arrow as the X-direction stage 5 moves towards the X direction.

FIG. 10 illustrates the first time of scanning in the X direction to draw patterns in a scan region highlighted with gray in FIG. 10. After the first scanning, the Y-direction stage 7 moves towards the Y direction, so as to move the substrate 1 towards the Y direction for a distance equal to the bandwidth W. FIG. 11 illustrates the second time of scanning in the X direction to draw patterns in the scan region highlighted with gray in FIG. 11. After the second scanning, the Y-direction stage 7 moves towards the Y direction, so as to move the substrate 1 further towards the Y direction for a distance equal to the bandwidth W. FIG. 12 illustrates the third time of scanning in the X direction to draw patterns in the scan region highlighted with gray in FIG. 12. After the third scanning, the Y-direction stage 7 moves towards the Y direction, so as to move the substrate 1 further towards the Y direction for a distance equal to the bandwidth W. FIG. 13 illustrates the fourth time of scanning in the X direction to draw patterns in the scan region highlighted with gray in FIG. 13, thereby completing scanning of the entire substrate 1.

In FIGS. 10˜13, it is exemplarily shown that the substrate 1 is scanned four times in the X direction, so as to scan the entire substrate 1. However, the present invention is not limited thereto. Within the spirit and scope of the present invention, the substrate 1 can also be scanned towards the X direction three times or fewer or five times or more, so as to complete the scanning of the entire substrate 1.

According to the above embodiments, the misalignment of the head 20a of each light beam irradiation device 20 is detected, and the detecting result is based on to modify the coordinate of the drawing data. Further, the drawing data with the modified coordinate is provided to the DMD driving circuit 27 of each light beam irradiation device 20, such that, even if misalignment occurs, the pattern can be drawn precisely. Therefore, pattern quality deterioration caused by the misalignment of the heads 20a of the light beam irradiation devices 20 can be prevented when several light beam irradiation devices 20 are used for scanning the substrate with a plurality of light beams.

Furthermore, according to the above-described embodiments, since the laser measurement system is used to detect the position of the chuck 10 accurately, the chuck 10 can be precisely positioned in the X and the Y directions. Moreover, the CCD cameras 51 which are disposed on the chuck 10 to receive light beams can be relied on to accurately detect the misalignment of the head 20a of each light beam irradiation device 20 in the X and the Y directions. Based on the above, the coordinate of the drawing data can be accurately modified for improving the preciseness of patterning.

Based on the embodiments described above, the CCD cameras 51 disposed on the chuck 10 are spaced by the same interval which separates the heads 20a of the light beam irradiation devices 20 for receiving the light beams from the heads 20a. Consequently, the movement range of the Y-direction stage 7 that is required for detecting the misalignment of the heads 20a of all the light beam irradiation devices 20 can be reduced. Accordingly, the area along the direction (Y direction) perpendicular to the scanning direction (X direction) of the substrate 1 by the light beams of exposure apparatus can be reduced.

The exposure apparatus or the exposure method of the present invention can be applied to exposure of the substrate. By using parallel light beams to scan the substrate, patterns can be drawn precisely, and the tact time for manufacturing high quality display panel substrates can be reduced.

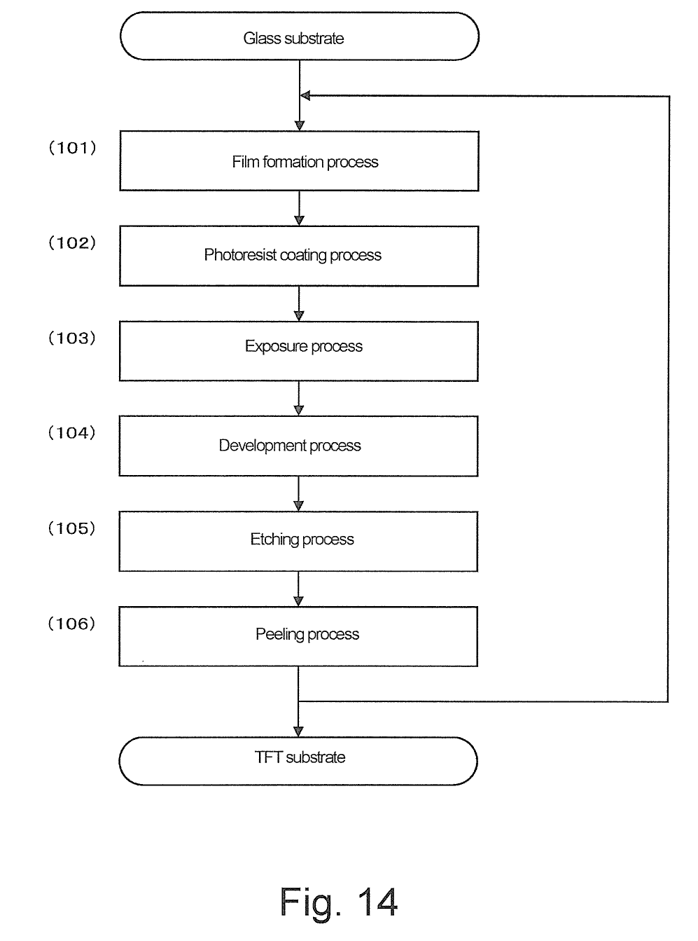

For example, FIG. 14 is a flowchart showing an exemplary process of fabricating a TFT substrate of a liquid crystal display device. In a film formation process (Step 101), a thin film such as a conductive film which is served as a transparent electrode for driving liquid crystal, or an insulating film is formed on the substrate by using a sputtering method or a chemical vapor deposition (CVD) method. In a photoresist coating process (Step 102), the photoresist is applied by a roll coating method so as to form a photoresist film on the thin film which is formed in film formation process (Step 101). In an exposure process (Step 103), a pattern is formed in the photoresist film by using the exposure apparatus. In a development process (Step 104), a development solution is applied onto the photoresist film, so as to remove an unnecessary portion of the photoresist film by using a method such as a shower development method. In an etching process (Step 105), a portion, which is not masked by the photoresist film, of the thin film formed in film formation process (Step 101) is removed by a wet etching method. In a peeling process (Step 106), the photoresist film which functions as a mask in etching process (Step 105) is peeled by using a peeling solution. It should be noted that some cleaning or drying processes need to be performed on the substrate before or after each of the aforementioned processes. After the aforementioned processes are repeated for several times, a TFT array is formed on the substrate.

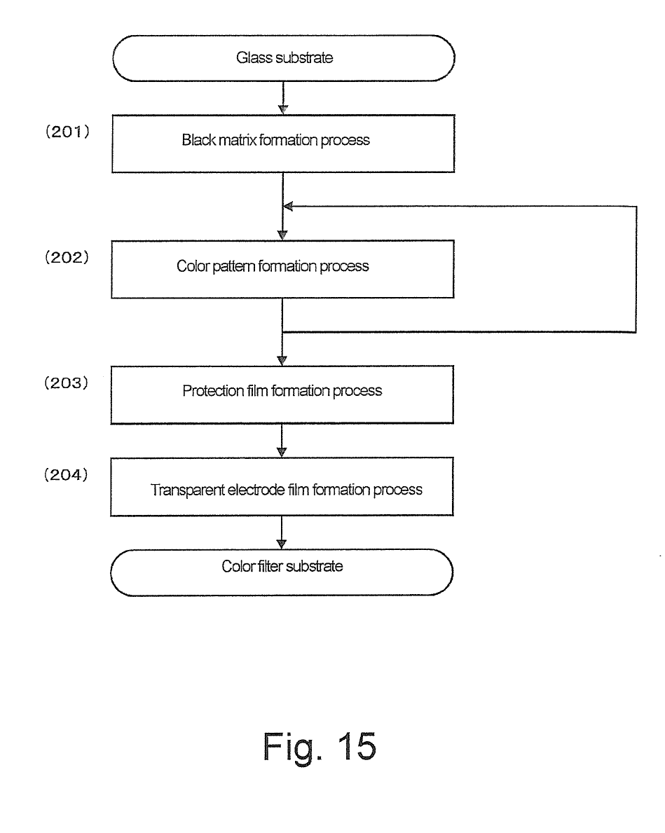

In addition, FIG. 15 is a flowchart showing an exemplary process of fabricating a color filter substrate of a liquid crystal display device. In a black matrix formation process (Step 201), the black matrix is formed on the substrate by the procedures such as photoresist coating, exposure, development, etching, peeling, and so forth. In a color pattern formation process (Step 202), the color pattern is formed on the substrate by using a method such as a printing method. This process can be repeated to form R, G and B color pattern. In a protection film formation process (Step 203), the protection film is formed on the color pattern. Further, in a transparent electrode film formation process (Step 204), the transparent electrode film is formed on the protection film. It should be noted that cleaning or drying processes may need to be performed on the substrate before or during or after each of the aforementioned processes.

The exposure apparatus or the exposure method of the present invention can be used in the exposure process (Step 103) of fabricating the TFT substrate in FIG. 14. Moreover, the exposure apparatus or the exposure method of the present invention can be used for exposure in the black matrix formation process (Step 201) and the color pattern formation process (Step 202) of fabricating the color filter substrate in FIG. 15.

Although the present invention has been described with reference to the above embodiments, it will be apparent to one of the ordinary skill in the art that modifications to the described embodiments may be made without departing from the spirit of the invention. Accordingly, the scope of the invention will be defined by the attached claims not by the above detailed descriptions.

What is claimed is:

1. An exposure apparatus, comprising:
a chuck supporting a substrate coated with a photoresist;
a stage moving the chuck; and
a plurality of light beam irradiation devices, each of the light beam irradiation devices comprising a spatial light modulator modulating a light beam, a driving circuit driving the spatial light modulator according to drawing data, and a head having an irradiation optical system emitting the light beam modulated by the spatial light modulator,
wherein the stage moves the chuck, the substrate is scanned by a plurality of light beams irradiated from the light beam irradiation devices to draw patterns on the substrate, the exposure apparatus being characterized by:
a position detecting means detecting a position of the chuck;
a controlling means controlling a movement of the stage to position the chuck according to a detecting result generated by the position detecting means;
a light receiving means disposed on the chuck to receive the light beam irradiated from the head of the light beam irradiation device;
a head-misalignment detecting means detecting the misalignment of the head of each of the light beam irradiation devices from the light beam received by the light receiving means; and
a means modifying a coordinate of the drawing data supplied to the driving circuit of each of the light beam irradiation devices based on a detecting result generated by the head-misalignment detecting means and supplying the drawing data with the modified coordinate to the driving circuit of each of the light beam irradiation devices.

2. The exposure apparatus as claimed in claim 1, wherein the position detecting means comprises a laser measurement system, and the laser measurement system comprises a laser source generating a laser, a reflecting means disposed on the chuck, and an interferometer measuring an interference of the laser generated by the laser source and the laser reflected by the reflecting means.

3. The exposure apparatus as claimed in claim 1, comprising a plurality of the light receiving means, wherein the light receiving means are disposed on the chuck and spaced by an interval which spaces the heads of the light beam irradiation devices.

4. An exposure method, comprising:
supporting a substrate coated with a photoresist by a chunk,
moving the chuck by a stage,
scanning the substrate using a plurality of light beams irradiated from a plurality of light beam irradiation devices to draw pattern on the substrate, each of the light beam irradiation devices comprising a spatial light modulator modulating the light beam, a driving circuit driving the spatial light modulator according to drawing data, and a head having an irradiation optical system emitting the light beam modulated by the spatial light modulator, the exposure method being characterized by:
detecting a position of the chuck;
controlling a movement of the stage to position the chuck according to a result of detecting the position of the chuck;
receiving the light beam irradiated from the head of the light beam irradiation device by a light receiving means disposed on the chuck;
detecting a misalignment of the head of each of the light beam irradiation devices from the received light beam;
modifying a coordinate of the drawing data supplied to the driving circuit of each of the light beam irradiation devices according to a result of detecting the misalignment of the head of each of the light beam irradiation devices; and
supplying the drawing data with the modified coordinate to the driving circuit of each light beam irradiation device.

5. The exposure method as claimed in claim 4, wherein the step of detecting the position of the chuck is performed by using the laser measurement system, and the laser measurement system comprises a laser source generating a laser, a reflecting means disposed on the chuck, and an interferometer measuring an interference of the laser generated by the laser source and the laser reflected by the reflecting means.

6. The exposure method as claimed in claim 4, wherein a plurality of light receiving means are disposed on the chuck and spaced by an interval which spaces the heads of the light beam irradiation devices for receiving the light beams irradiated from the heads of the light beam irradiation devices.

7. A method of manufacturing a display panel substrate, the method being characterized by adopting the exposure apparatus as claimed in claim 1 to expose the substrate.

8. A method of manufacturing a display panel substrate, the method being characterized by adopting the exposure method as claimed in claim 4 to expose the substrate.
